(19) United States
(12) Patent Application Publication
(10) Pub. No.: US 2014/0262411 A1
(43) Pub. Date: Sep. 18, 2014

(54) EXTENDED CURL S-SHIELD

(71) Applicant: CommScope, Inc. of North Carolina, Hickory, NC (US)

(72) Inventors: Wayne C. HOPKINSON, Hickory, NC (US); Trent M. HAYES, Hickory, NC (US); David A. WIEBELHAUS, Hickory, NC (US); Daniel J. PARKE, Hickory, NC (US); Douglas R. BRAKE, Denver, NC (US)

(73) Assignee: CommScope, Inc. of North Carolina, Hickory, NC (US)

(21) Appl. No.: 14/210,965

(22) Filed: Mar. 14, 2014

Related U.S. Application Data
(60) Provisional application No. 61/787,330, filed on Mar. 15, 2013.

(51) Int. Cl. H01B 11/08; H01B 11/02

(52) U.S. Cl. CPC H01B 11/085; H01B 11/02
USPC 174/34; 174/113 R

(57) ABSTRACT

A cable includes a jacket surrounding a cable core. The cable core includes four twisted pairs. One or more S-shaped separators are disposed amongst the twisted pairs. The S-Shaped separators may be formed with two layers or three layers, wherein at least one layer is conductive. Where two S-shaped separators are disposed within the cable, a third conductive tape may be used to electrically connect the first and second S-shaped separators. In alternative embodiments, one or both ends of an S-shaped separator make electrical contact to mid-portions of the separator to create one or two shielding cambers within the cable.

This application claims the benefit of U.S. Provisional Application No. 61/787,330, filed Mar. 15, 2013, which is herein incorporated by reference.

### BACKGROUND OF THE INVENTION

1. Field of the Invention

The present invention relates to a twisted pair cable for communication of high speed signals, such as a local area network (LAN) cable. More particularly, the present invention relates to a twisted pair cable having at least one conductive separator tape between twisted pairs within the cable, which reduces or eliminates the likelihood of transmission errors because of internal or alien crosstalk, and hence allows for a relatively higher bit rate transmission.

2. Description of the Related Art

Along with the greatly increased use of computers for homes and offices, there has developed a need for a cable, which may be used to connect peripheral equipment to computers and to connect plural computers and peripheral equipment into a common network. Today's computers and peripherals operate at ever increasing data transmission rates. Therefore, there is a continuing need to develop a cable, which can operate substantially error-free at higher bit rates, by satisfying numerous elevated operational performance criteria, such as a reduction in internal and alien crosstalk when the cable is in a high cable density application. e.g. routed alongside other cables.

FIGS. 1 and 2 show a typical shielded twisted pair cable 1 and a twisting scheme employed for the four pairs of wires (a first pair A, a second pair B, a third pair C and a fourth pair D). A dielectric separator tape 3 separates twisted pairs A and C from twisted pairs B and D. The twisted pairs A, B, C and D in combination with the separator tape may be twisted in the direction of arrow 5 (e.g., opposite to the twist direction of the twisted pairs A, B, C and D) to form a stranded core. The stranded core is surrounded by a shielding layer 7. The shielding layer 7 may be formed of a conductive foil, and the foil's edges may partially overlap at area 9. A dielectric jacket 11 then surrounds the shielding layer 7.

Each twisted wire pair A, B, C and D includes two insulated conductors. Specifically, the first twisted wire pair A includes a first insulated conductor 13 and a second insulated conductor 15. The second twisted wire pair B includes a third insulated conductor 17 and a fourth insulated conductor 19. The third twisted wire pair C includes a fifth insulated conductor 21 and a sixth insulated conductor 23. The fourth twisted wire pair D includes a seventh insulated conductor 25 and an eighth insulated conductor 27.

Each twisted wire pair A, B, C and D is formed by having its two insulated conductors continuously twisted around each other. For the first twisted wire pair A, the first conductor 13 and the second conductor 15 twist completely about each other, three hundred sixty degrees (a), at a first interval w along the length of the cable 1. For the second twisted wire pair B, the third conductor 17 and the fourth conductor 19 twist completely about each other, three hundred sixty degrees (b), at a second interval x along the length of the cable 1. For the third twisted wire pair C, the fifth conductor 21 and the sixth conductor 23 twist completely about each other, three hundred sixty degrees (c), at a third interval y along the length of the cable 1. For the fourth twisted wire pair D, the seventh conductor 25 and the eighth conductor 27 twist completely about each other, three hundred sixty degrees (d), at a fourth interval z along the length of the cable 1.

Each of the wire pairs A, B, C and D has a fixed twist interval w, x, y, z, respectively. Each of the twist intervals w, x, y, z is different from the twist interval of the other wire pairs. As is known in the art, such an arrangement assists in reducing crosstalk between the wire pairs within the cable 1, which is referred to as internal crosstalk. In one embodiment of the prior art, each of the twisted wire pairs A, B, C and D has a unique fixed twist interval of slightly more than, or less than, 0.500 inches. Table 1 below summarizes the twist interval ranges for the twisted pairs A, B, C and D.

TABLE 1

| | | Min. | Max |
|---|---|---|---|
| Twisted | | Twist | Twist |
| Pair | Twist Length | Length | Length |
| A | 0.440 | 0.430 | 0.450 |
| B | 0.410 | 0.400 | 0.420 |
| C | 0.596 | 0.580 | 0.610 |
| D | 0.670 | 0.650 | 0.690 |

A cable 1, as described above and depicted in FIGS. 1 and 2, has enjoyed success in the industry. However, with the ever-increasing demand for faster data rate transmission speeds, it has become apparent, that the cable 1 of the prior art suffers drawbacks. For example, the background art's cable 1 exhibits unacceptable levels of internal and alien near end crosstalk at higher data transmission rates.

### SUMMARY OF THE INVENTION

The Applicant has appreciated that at higher data transmission rates, the internal and alien crosstalk are more problematic. The crosstalk transmitted from, and received by, the pairs with the longer twist lengths are the most problematic. Therefore, in the prior art, the dielectric separator 3 is placed so as to separate and distance the two twisted pairs C and D with the longest twist lengths y and z. However, this technique of employing the separator 3 may be insufficient when the data transmission rate is increased.

Hence, a new cable structure to reduce the influences of internal and alien crosstalk is needed in the art as the data transmission rates are increased.

The Applicant has invented a twisted pair cable with new structural features, the object of which is to enhance one or more performance characteristics of a LAN cable, such as reducing internal and alien crosstalk, insertion loss, matching impedance, reducing propagation delay and/or balancing delay skew between twisted pairs, and/or to enhance one or more mechanical characteristics of a LAN cable, such as improving flexibility, reducing weight, reducing cable diameter and/or reducing smoke emitted in the event of a fire.

These and other objects are accomplished by a cable that includes a jacket surrounding a cable core. The cable core includes four twisted pairs. One or more S-shaped separators are disposed amongst the twisted pairs. The S-Shaped separators may be formed with two layers or three layers, wherein at least one layer is conductive. Where two S-shaped separators are disposed within the cable, a third conductive tape may be used to electrical connect the first and second S-shaped separators. In alternative embodiments, one or both ends of an S-shaped separator make electrical contact to mid-portions of the separator to create one or two shielding cambers within the cable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a shielded, twisted pair cable, in accordance with the prior art;

FIG. 2 is a cross sectional view taken along line II-II in FIG. 1;

FIG. 3 is a perspective view of a twisted pair cable, in accordance with a first embodiment of the present invention;

FIG. 4 is a cross sectional view taken along line IV-IV in FIG. 3;

FIG. 5 is a cross sectional view taken along line V-V in FIG. 4;

FIG. 6 is a cross sectional view, similar to FIG. 4, but showing a twisted pair cable, in accordance with a second embodiment of the present invention;

FIG. 6A is a close-up view of a fold in the outer shielding layer in FIG. 6;

FIG. 7 is a cross sectional view taken along line VII-VII in FIG. 6;

FIG. 8 is a cross sectional view, similar to FIG. 6, but showing a twisted pair cable, in accordance with a third embodiment of the present invention;

FIG. 9 is a cross sectional view, similar to FIG. 8, but showing a twisted pair cable, in accordance with a fourth embodiment of the present invention;

FIG. 10 is a cross sectional view, similar to FIG. 4, but showing a twisted pair cable, in accordance with a fifth embodiment of the present invention; and

FIG. 11 is a cross sectional view of a cable including two S-shaped tape separators;

FIG. 12 is a cross sectional view showing a twisted pair cable, in accordance with a first alternative to the arrangement in FIG. 11;

FIG. 13 is a cross sectional view showing a twisted pair cable, in accordance with a second alternative to the arrangement in FIG. 11;

FIG. 14 is a cross sectional view showing a twisted pair cable, in accordance with a third alternative to the arrangement in FIG. 11;

FIG. 14A is a cross sectional view showing a modification of the cable in FIG. 14;

FIG. 15 is a cross sectional view showing a twisted pair cable, in accordance with a fourth alternative to the arrangement in FIG. 11; and

FIG. 16 is a cross sectional view showing an alternative twisted pair structure, which may be substituted in the above embodiments.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

FIG. 3 is a perspective view of a twisted pair cable 31A, in accordance with a first embodiment of the present invention. FIG. 4 is a cross sectional view of the cable 31A taken along line IV-IV in FIG. 3. The cable 31A includes a jacket 32 formed around and surrounding a cable core. The cable core includes first, second, third and fourth twisted pairs 33, 34, 35 and 36. The cable core may also include an outer shielding layer 7′ surrounding the first, second, third and fourth twisted pairs 33, 34, 35 and 36. The outer shielding layer 7′ may be formed of a conductive layer, e.g., a foil layer, on a nonconductive layer, e.g., a mylar layer, and the edges of the outer shielding layer 7′ may partially overlap at area 9′. The jacket 32 may be formed of polyvinylchloride (PVC), low smoke zero halogen, polyethylene (PE), fluorinated ethylene propylene (FEP), polyvinylidene fluoride (PVDF), ethylene chlorotrifluoroethylene (ECTFE), or other foamed or solid materials common to the cabling art.

The first twisted pair 33 includes a first insulated conductor 37 formed by a first insulating material 37A surrounding a first conductor 37B, and a second insulated conductor 38 formed by a second insulating material 38A surrounding a second conductor 38B, wherein said first and second insulated conductors 37 and 38 are twisted about each other to form the first twisted pair 33.

The second twisted pair 34 includes a third insulated conductor 39 formed by a third insulating material 39A surrounding a third conductor 39B, and a fourth insulated conductor 40 formed by a fourth insulating material 40A surrounding a fourth conductor 40B, wherein said third and fourth insulated conductors 39 and 40 are twisted about each other to form the second twisted pair 34.

The third twisted pair 35 includes a fifth insulated conductor 41 formed by a fifth insulating material 41A surrounding a fifth conductor 41B, and a sixth insulated conductor 42 formed by a sixth insulating material 42A surrounding a sixth conductor 42B, wherein said fifth and sixth insulated conductors 41 and 42 are twisted about each other to form the third twisted pair 35.

The fourth twisted pair 36 includes a seventh insulated conductor 43 formed by a seventh insulating material 43A surrounding a seventh conductor 43B, and an eighth insulated conductor 44 formed by an eighth insulating material 44A surrounding an eighth conductor 44B, wherein said seventh and eighth insulated conductors 43 and 44 are twisted about each other to form the fourth twisted pair 36.

The twist lengths w, x, y and z of the first, second, third and fourth twisted pairs 33, 34, 35 and 36 may be the same as listed in Table 1 for twisted pairs A, B, C and D, respectively. For example, a first twist length w of the first twisted pair 33 may be shorter than a third twist length y of the third twisted pair 35, and a second twist length x of the second twisted pair 34 may be shorter than a fourth twist length z of the fourth twisted pair 36. It should be noted that other twist lengths than those listed in Table 1 may be employed while practicing the benefits of the present invention.

The first through eighth insulating materials 37A-44A may be formed of a flexible plastic material having flame retardant and smoke suppressing properties, such as a polymer or foamed polymer, common to the cabling art, like fluorinated ethylene propylene (FEP), polyethylene (PE) or polypropylene (PP). A radial thickness of the first through eighth insulating materials 37A-44A would typically be greater than seven mils, such as about tens mils or about eleven mils. The first through eighth conductors 37B-44B may be solid or stranded, and may be formed of a conductive metal or alloy, such as copper. In one embodiment, the first through eighth conductors 37B-44B are each a solid, copper wire of about twenty three gauge size.

In one embodiment of the invention, the first and third twisted pairs 33 and 35 reside in approximately a first half of the cable 31A, and the second and fourth twisted pairs 34 and 36 reside in approximately a second half of the cable 31A. A region R between the first and second halves of the cable 31A defines a middle region. The middle region R is defined at a particular cross section of the cable, as depicted in the drawings. Of course, if the core of the cable 31A is stranded, the middle region R would rotate to different positions, as the core strand correspondingly rotates along the length of the cable 31A.

A separator tape 51A is located within the jacket 32 and separates the first and third twisted pairs 33 and 35 from the second and fourth twisted pairs 34 and 36. The tape separator 51A has a first edge 53 and an opposite second edge 55. The first and second edges 53 and 55 extend in a same general direction as an extension length of the cable 31A. The first edge 53 is disposed proximate the first twisted pair 33. The tape separator 51A extends from the first edge 53 at least partially around the first twisted pair 33, through said middle region R, then at least partially around the second twisted pair 34, and ends at the second edge 55. The resulting cross sectional shape of the separator tape 51A is S-shaped. Of course, the S-shape shown in FIG. 4 could be a mirror image about a vertical mid-axis, to make a backwards S-shape.

As seen in FIG. 3, the cable core may be twisted in the direction of arrow 30 to form a core strand. In the illustrated embodiment, the direction 30 is opposite to the twist directions of the first, second, third and fourth twisted pairs 33, 34, 35 and 36 and may offer advantages as discussed in the Assignee's U.S. Pat. No. 6,770,819, which is incorporated herein by reference. However, this is not a necessary feature, as the benefits of the present invention will still be apparent with the core strand's direction 30 being the same as the pair twist directions. The core strand length may be approximately two inches, although other lengths may be employed within the spirit of the present invention.

FIG. 5 is a cross sectional view taken along line V-V in FIG. 4. FIG. 5 shows the construction of the tape separator 51A. The tape separator 51A is formed of a first layer 57 and a second layer 59. The first layer 57 is nonconductive and the second layer 59 is conductive. In one embodiment, the first layer 57 is formed of a polyester film, and the second layer 59 is formed of a conductive foil. One suitable material for the polyester film is biaxially-oriented polyethylene terephthalate, e.g., Mylar®, and one suitable material for the conductive foil is aluminum, although other materials may be selected. Suitable thicknesses might be less than 1 mil for each of the first and second layers 57 and 59.

The nonconductive, first layer 57 provides strength, while the conductive, second layer 59 provides the S-shaped tape separator 51A with its shielding qualities. Hence, the tape separator 51A has electrically conductive properties to shield the first and third twisted pairs 33 and 35 from the second and fourth twisted pairs 34 and 36. The tape separator 51A greatly reduces the occurrence of internal crosstalk in the cable, whereas the outer shielding layer 7′ greatly reduces alien crosstalk.

FIG. 6 is a cross sectional view, similar to FIG. 4, but showing a twisted pair cable 31B, in accordance with a second embodiment of the present invention. In the second embodiment, the first edge 53 of a tape separator 51B is in electrical contact with a first mid-portion 54 of the tape separator 51B proximate the middle region R. Also, the second edge 55 of the tape separator 51B is in electrical contact with a second mid-portion 56 of the tape separator 51B proximate the middle region R. The electric contact will be better understood with reference to FIG. 7.

FIG. 7 is a cross sectional view taken along line VII-VII in FIG. 6. The tape separator 51B is formed of at least three layers. A first layer 61 being conductive, a second layer 62 being nonconductive, and a third layer 63 being conductive. The second layer 62 is located between the first layer 61 and the third layer 63. The materials used for the conductive, first and third layers 61 and 63, and the non-conductive, second layer 62 may be the same as the materials described in conjunction with FIG. 5.

As illustrated in FIG. 6, the third layer 63 at the first edge 53 of the tape separator 51B is in electrical contact with the third layer 63 at the first mid-portion 54 of the tape separator 51B proximate the middle region R. Also, the first layer 61 at the second edge 55 of the tape separator 51B is in electrical contact with the first layer 61 at the second mid-portion 56 of the tape separator 51B proximate the middle region R. Also, the tape separator 51B is in electrical contact with the outer shielding layer 7′ at points W and H. More specifically, the first layer 61 is in electrical contact with the conductive layer 59 of the outer shielding layer 7′ at point W, and the third layer 63 is also in electrical contact with the conductive layer 59 of the outer shielding layer 7′ at point H. By this arrangement, internal crosstalk is greatly reduced, as the signals of each twisted pair are shielded from the signals of the other twisted pairs.

The cable design of FIG. 6 also greatly reduces alien crosstalk. In other words, the signals of the first, second, third and fourth twisted pairs 33, 34, 35 and 36 are shielded from signals of twisted pairs in other adjacent cables via the outer shielding layer 7′. Optionally, the outer shielding layer's conductive layer 59 is in electrical contact with itself at the overlap 9′, due to a fold F, as best seen in the close-up view of FIG. 6A. The fold arrangement illustrated for the outer shielding layer 7′ could also be employed for the tape separator 51B, such that the tape separator 51B would be formed as a two layer member, e.g., like FIG. 5, with folds F used at the first and/or second ends 53 and 55 to establish electrical conductivity to the first mid-portions 54 and/or 56.

During experimentation, the embodiment of FIG. 4 proved sufficient for lower signal speeds, however at higher signal speeds, the open area between the first and third pairs 33 and 35, and the open area between the second and fourth pairs 34 and 36 allowed unacceptable internal crosstalk. Hence, the embodiment of FIG. 6 is preferred for twisted pair cables operating at higher signal speeds.

FIG. 8 is a cross sectional view, similar to FIG. 6, but showing a twisted pair cable 31C, in accordance with a third embodiment of the present invention. FIG. 8 illustrates the same electrical contact at the first end 53 of the tape separator 51C to the first mid-portion 54 of the tape separator 51C, however the second end 55 of the tape separator 51C is not in electrical contact with the second mid-portion 56 of the tape separator 51C. The separator tape 51C may be a two layer version as illustrated in the cross sectional view of FIG. 5. As illustrated in FIG. 8, the conductive second layer 59 at the first edge 53 of the tape separator 51C is in electrical contact with the same conductive, second layer 59 at the first mid-portion 54 of the tape separator 51C.

The embodiment of FIG. 8 could prove beneficial in a situation where the internal crosstalk between the second and fourth twisted pairs 34 and 36 is not very problematic, e.g., the twist length is very different and/or the signal speed for the deployment application is not very high. The embodiment of FIG. 8 offers the advantages of a lesser amount of material within the cable 31C, e.g., to reduce the weight and/or smoke emission in the case of a fire, or to improve the flexibility of the cable 31C and potentially a reduced manufacturing cost.

FIG. 9 has the same features as FIG. 8, but shows a twisted pair cable 31D wherein the first end 53 of tape separator 51D is tucked in rather than out in comparison the arrangement of FIG. 8. In FIG. 9, the first end 53 would establish electrical contact to the second mid-portion 56 of the tape separator 51D. In FIG. 9, the tape separator 51D has the three layer cross section, as shown in FIG. 7. Alternatively, the tape separator 51D could be a two layer member, as shown in FIG. 5, and the first end 53 could include a fold, e.g., like FIG. 6A, to create an electrical connection to the mid-portion 56 of the separator tape 51D.

Although FIGS. 8 and 9 illustrate the encirclement of the first twisted pair 33 by the tape separator 51C or 51D, it should be appreciated that the second twisted pair 34 could be encircled by the tape separator 51C or 51D. Also, depending upon the relative twist lengths of the pairs and the problematic pairs within the cable 31C or 31D, the S-shaped tape separator 51C or 51D may be reoriented to interact with the third and fourth twisted pairs 35 and 36. Similar to FIGS. 8 and 9, either of the third or fourth twisted pairs 35 or 36 may be encircled by the tape separator 51C or 51D. Also, similar to FIG. 6, both of the third and fourth twisted pairs 35 and 36 may be encircled by the tape separator 51C or 51D in either the tucked out manner (FIG. 8) or the tucked in manned (FIG. 9).

FIG. 10, is an embodiment of a cable 31E in accordance with the present invention, which is identical to FIG. 4, except the outer shielding layer 7′ is not provided. Should alien crosstalk be of lower concern, e.g., in the instance where the cable 31E is not to be routed alongside adjacent twisted pair cables, or in an area not susceptible to electromagnetic interference (EMF), then an outer shielding layer 7′ may not be required, and hence manufacturing costs may be reduced. Each of the embodiments discussed above in relation to FIGS. 6, 8 and 9, and the alterations to those embodiments as mentioned above, may also be employed without the outer shielding layer 7′ where alien crosstalk is not considered problematic.

FIG. 11 illustrates an embodiment of a cable 100A in accordance with the present invention employing two S-shaped separators. In FIG. 11, a first S-shaped tape separator 101 interacts with the first and fourth twisted pairs 33 and 36. The first tape separator 101 has a first edge 153 and an opposite second edge 155. The first edge 153 is disposed proximate the first twisted pair 33. The first tape separator 101 extends from the first edge 153 at least partially around the first twisted pair 33, through the middle region R, then at least partially around the fourth twisted pair 36, and ends at the second edge 155. The resulting cross sectional shape of the first separator tape 101 is S-shaped.

In FIG. 11, a second S-shaped tape separator 103 interacts with the second and third twisted pairs 34 and 35. The second tape separator 103 has a first edge 152 and an opposite second edge 154. The first edge 152 is disposed proximate the third twisted pair 35. The second tape separator 103 extends from the first edge 152 at least partially around the third twisted pair 35, through the middle region R, then at least partially around the second twisted pair 34, and ends at the second edge 154. The resulting cross sectional shape of the second separator tape 103 is S-shaped.

In FIG. 11, a third tape separator 105 interacts with the first and second tape separators 101 and 103. The third tape separator 105 extends from a first end 161 to a second end 162. Each of the first, second and third tape separators 101, 103 and 105 may be formed with three layers in accordance with FIG. 7. The purpose of the third tape separator 105 is to establish an electrical connection between the first tape separator 101 and the second tape separator 103.

FIG. 12 illustrates an embodiment of a cable 100B in accordance with the present invention employing two reversed S-shaped separators 101 and 103. FIG. 12 is identical to FIG. 11, except that the first and second tape separators 101 and 103 are curved to resemble reverse S-shapes rather than S-shapes. FIG. 13 illustrates an embodiment of a cable 100C in accordance with the present invention which is the same as the embodiment of FIG. 12 except that the third separator 105 has been reoriented ninety degrees as compared to FIGS. 11 and 12. The third separator 105 still functions to establish electrical contact between the first and second tape separators 101 and 103.

FIG. 14 illustrates an embodiment of a cable 100D in accordance with the present invention employing two reversed S-shaped separators 101 and 103. FIG. 14 demonstrates that the first and second tape separators 101 and 103 can establish direct electrical contact without the intervening third tape separator 105. However, as illustrated in FIG. 14, the third and fourth twisted pairs 35 and 36 have no shielding layer disposed between them. The arrangement of FIG. 14 could be suitable where internal crosstalk between the third and fourth twisted pairs 35 and 36 is not problematic, e.g., due to a great difference in twist lengths and/or a slower signal speed. As illustrated in FIG. 14A, the ends of the first tape separator 101 may be extended to contact mid-portions of the first tape separator 101, in a same manner as depicted in FIG. 6, where the ends 53 and 54 of the tape separator 51B extend to contact the first and second mid-portions 54 and 56 of the tape separator 51B. Likewise, the second tape separator 103 may have extended ends. FIG. 14 also illustrates the outer shielding layer 7′. However, the outer shielding layer 7′ is optional and/or may be removed if the cable 100D is employed in an environment where alien crosstalk is not problematic, e.g., the cable 100D is not adjacent to other cables or sources emitting or susceptible to EMF.

FIG. 15 illustrates an embodiment of a cable 100E in accordance with the present invention employing two reversed S-shaped separators 101 and 103 and the intervening third tape separator 105′. FIG. 15 is similar to FIG. 13 except for the absence of the outer shielding layer 7′ and the construction of the third tape separator 105′. The third tape separator 105′ is formed as a two layer structure, as shown in FIG. 5, and includes a fold at 112, similar to FIG. 6A. The cable 100E would exhibit excellent internal crosstalk performance between the first, second, third and fourth twisted pairs 33, 34, 35 and 36, but less resistance to alien crosstalk as compared to the embodiment of FIG. 13 due to the absence of the outer shielding layer 7′. Of course, the embodiments of FIGS. 11 and 12 may have the outer shielding layers 7′ removed as well if the cables are employed in environments where alien crosstalk is not problematic, e.g., the cables are not adjacent to other cables or sources emitting or susceptible to EMF.

In the embodiments of FIGS. 4, 6, 8-13 and 15, the first and third twisted pairs 33 and 35 are shielded from the second and fourth twisted pairs 34 and 36. Hence, it is no longer necessary to have four different twist lengths within a cable to reduce the internal crosstalk. Rather, it is only required to have two different twist lengths employed in the cable. For example, the first twist length w may equal the second twist length x, and the third twist length y may equal the fourth twist length z.

Such an arrangement offers several advantages. First, there are more design freedoms in the cable to tune the cable to a specific performance characteristic. When the cable required four different twist lengths, there was a minimum twist length w, a maximum twist length Z, and two different intermediate twist lengths x and y. The smaller twist length w was paired with the larger intermediate twist length y on one side of the separator 3, and the largest twist length z was paired with the smaller intermediate twist length x on the other side of the separator 3. This pairing was a compromise that allowed for a sufficient difference in the twist lengths for twisted pairs that were on a same side of the separator 3. The cable would have performed poorly if the smallest twist length w and the largest twist length z were deployed on one side of the separator 3, and the two intermediate twist lengths x and y were deployed on the other side of the separator 3 because the twist length difference between the two intermediate twist lengths x and y would have been insufficient to prevent internal crosstalk between the two twisted pairs 34 and 35 at high data speeds.

With the cables of the present invention, one could employ the smallest twist length w adjacent to the longest twist length z on one side of the separator 51. Because of the greater difference in twist lengths the internal crosstalk between the two grouped twisted pairs should be relatively improved as compared to the prior art situation where the smallest twist length w was paired with the larger intermediate twist length y. Since, the tape separators of the above noted embodiments completely isolate the first and third twisted pairs 33 and 35 from the second and fourth twisted pairs 34 and 36, the two twisted pairs on the other side of the middle region R can also employ twist lengths of w and z, respectively.

A second advantage is that there are fewer “types” of twisted pairs used in the cable. In the prior art, a cable manufacturer needs to assemble and store twisted pairs having four different twist lengths, e.g., twist lengths of w, x, y and z. In the cables of the noted embodiments of the present invention, the cable manufacturer needs to only manufacture and store twisted pairs having two different twist lengths, e.g., w and z, or perhaps w and y.

In the embodiments of FIGS. 6 and 11-13, each twisted pair is completely isolated from the other twisted pairs within the cable (potential internal crosstalk) and from twisted pairs in other cables (potential alien crosstalk). In such embodiments, it would be possible to have all of the twisted pairs having the same twist lengths, hence furthering the advantages noted above concerning the deployment of only two twists lengths for the twisted pairs.

The alien crosstalk performance in the above described embodiments could be enhanced by employing a striated jacket, as shown in U.S. Pat. No. 5,796,046 and published U.S. Application 2005/0133246, both of which are herein incorporated by reference. The alien crosstalk performance could be further enhanced by employing twist modulation and/or core strand modulation, as shown in the Assignee's U.S. Pat. No. 6,875,928, which is incorporated herein by reference.

FIG. 16 is a cross sectional view showing an alternative twisted pair 33′ which allows the insulation layers 37A′ and 38A′ surrounding the conductors 37B and 38B to be made thinner (e.g., less than 7 mils, such as 5 or 6 mils in radial thickness), which can lead to improvements in cable performance as detailed in the Assignee's prior U.S. Pat. No. 7,999,184, which is incorporated herein by reference. One, two, three or all of the first, second, third and fourth twisted pairs 33, 34, 35 and 36 may be replaced with the twisted pair configuration illustrated in FIG. 16, which includes an interposed dielectric tape 110. Although FIG. 10 depicts a particular shape for the dielectric tape 110, other shapes may be employed, such as those shown in the above mentioned U.S. Pat. No. 7,999,184.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A cable comprising:
a first conductor; a first insulating material surrounding said first conductor to form a first insulated conductor; a second conductor; and a second insulating material surrounding said second conductor to form a second insulated conductor, wherein said first and second insulated conductors are twisted about each other to form a first twisted pair;
a third conductor; a third insulating material surrounding said third conductor to form a third insulated conductor; a fourth conductor; and a fourth insulating material surrounding said fourth conductor to form a fourth insulated conductor, wherein said third and fourth insulated conductors are twisted about each other to form a second twisted pair;
a fifth conductor; a fifth insulating material surrounding said fifth conductor to form a fifth insulated conductor; a sixth conductor; and a sixth insulating material surrounding said sixth conductor to form a sixth insulated conductor, wherein said fifth and sixth insulated conductors are twisted about each other to form a third twisted pair;
a seventh conductor; a seventh insulating material surrounding said seventh conductor to form a seventh insulated conductor; an eighth conductor; and an eighth insulating material surrounding said eighth conductor to form an eighth insulated conductor, wherein said seventh and eighth insulated conductors are twisted about each other to form a fourth twisted pair;
a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and
a conductive tape separator disposed within said jacket, said conductive tape separator having a first edge and an opposite second edge, wherein said conductive tape separator extends from said first edge at least partially around said first twisted pair, through said middle region, at least partially around said second twisted pair, and ends at said second edge, wherein at least one of said first edge of said tape separator and said second edge of said conductive tape separator is in electrical contact with a mid-portion of said conductive tape separator proximate said middle region.

2. The cable according to claim 1, wherein said first edge of said conductive tape separator is in electrical contact with a first mid-portion of said conductive tape separator proximate said middle region, and said second edge of said conductive tape separator is in electrical contact with a second mid-portion of said conductive tape separator proximate said middle region.

3. The cable according to claim 1, further comprising:
an outer shielding layer, wherein said outer shielding layer surrounds said first, second, third and fourth twisted pairs, and resides within said jacket.

4. The cable according to claim 3, wherein said outer shielding layer is in electrical contact with said conductive tape separator.

5. The cable according to claim 3, wherein said outer shielding layer is formed of at least two layers, with a first layer being conductive and a second layer being nonconductive, and wherein said conductive layer of said outer shielding layer is in direct electrical contact with said conductive tape separator in a first area adjacent said first twisted pair, and wherein said conductive layer of said outer shielding layer is in direct electrical contact with said conductive tape separator in a second area adjacent said second twisted pair.

6. The cable according to claim 1, wherein said third twisted pair resides on an opposite side of said conductive tape separator as compared to said fourth twisted pair.

7. The cable according to claim 1, wherein said tape separator is formed of at least three layers, with a first layer being conductive, a second layer being nonconductive, and a third layer being conductive, and wherein said second layer is located between said first and third layers.

8. The cable according to claim 7, wherein said first and second layers are formed of a conductive foil and said second layer is formed of polyester film.

9. A cable comprising:
a first conductor; a first insulating material surrounding said first conductor to form a first insulated conductor; a second conductor; and a second insulating material surrounding said second conductor to form a second insulated conductor, wherein said first and second insulated conductors are twisted about each other to form a first twisted pair;
a third conductor; a third insulating material surrounding said third conductor to form a third insulated conductor; a fourth conductor; and a fourth insulating material surrounding said fourth conductor to form a fourth insulated conductor, wherein said third and fourth insulated conductors are twisted about each other to form a second twisted pair;
a fifth conductor; a fifth insulating material surrounding said fifth conductor to form a fifth insulated conductor; a sixth conductor; and a sixth insulating material surrounding said sixth conductor to form a sixth insulated conductor, wherein said fifth and sixth insulated conductors are twisted about each other to form a third twisted pair;
a seventh conductor; a seventh insulating material surrounding said seventh conductor to form a seventh insulated conductor; an eighth conductor; and an eighth insulating material surrounding said eighth conductor to form an eighth insulated conductor, wherein said seventh and eighth insulated conductors are twisted about each other to form a fourth twisted pair;
a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and
a conductive tape separator disposed within said jacket, said conductive tape separator having a first edge and an opposite second edge, wherein said conductive tape separator extends from said first edge at least partially around said first twisted pair, through said middle region, at least partially around said second twisted pair, and ends at said second edge, wherein said conductive tape separator is formed of at least three layers, with a first layer being conductive, a second layer being nonconductive, and a third layer being conductive, and wherein said second layer is located between said first and third layers.

10. The cable according to claim 9, further comprising:
an outer shielding layer, wherein said outer shielding layer surrounds said first, second, third and fourth twisted pairs, and resides within said jacket.

11. The cable according to claim 10, wherein said outer shielding layer is in electrical contact with said conductive tape separator.

12. The cable according to claim 10, wherein said outer shielding layer is formed of at least two layers, with a first layer being conductive and a second layer being nonconductive, and wherein said conductive layer of said outer shielding layer is in direct electrical contact with said conductive tape separator in a first area adjacent said first twisted pair, and wherein said conductive layer of said outer shielding layer is in direct electrical contact with said conductive tape separator in a second area adjacent said second twisted pair.

13. A cable comprising:
a first conductor; a first insulating material surrounding said first conductor to form a first insulated conductor; a second conductor; and a second insulating material surrounding said second conductor to form a second insulated conductor, wherein said first and second insulated conductors are twisted about each other to form a first twisted pair;
a third conductor; a third insulating material surrounding said third conductor to form a third insulated conductor; a fourth conductor; and a fourth insulating material surrounding said fourth conductor to form a fourth insulated conductor, wherein said third and fourth insulated conductors are twisted about each other to form a second twisted pair;
a fifth conductor; a fifth insulating material surrounding said fifth conductor to form a fifth insulated conductor; a sixth conductor; and a sixth insulating material surrounding said sixth conductor to form a sixth insulated conductor, wherein said fifth and sixth insulated conductors are twisted about each other to form a third twisted pair;
a seventh conductor; a seventh insulating material surrounding said seventh conductor to form a seventh insulated conductor; an eighth conductor; and an eighth insulating material surrounding said eighth conductor to form an eighth insulated conductor, wherein said seventh and eighth insulated conductors are twisted about each other to form a fourth twisted pair;
a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region;
a first conductive tape separator disposed within said jacket, said first conductive tape separator having a first edge and an opposite second edge, wherein said first conductive tape separator extends from said first edge at least partially around said first twisted pair, through said middle region, at least partially around said fourth twisted pair, and ends at said second edge;
a second conductive tape separator disposed within jacket, said second conductive tape separator having a third edge and an opposite fourth edge, wherein said second conductive tape separator extends from said third edge at least partially around said third twisted pair, through said middle region, at least partially around said second twisted pair, and ends at said fourth edge; and
an outer shielding layer, wherein said outer shielding layer surrounds said first, second, third and fourth twisted pairs, and resides within said jacket.

14. The cable according to claim 13, further comprising:
a third conductive tape separator disposed between said first and second conductive tape separators, wherein said third tape separator establishes conductivity between said first conductive tape separator and said second conductive tape separator.

15. The cable according to claim 14, wherein said third conductive tape separator is formed of at least three layers, with a first layer being conductive, a second layer being nonconductive, and a third layer being conductive, and wherein said second layer is located between said first and third layers.

16. The cable according to claim 15, wherein said first conductive layer of said third conductive tape separator is in direct electrical contact with said first conductive tape separator, and wherein said second conductive layer of said third conductive tape separator is in direct electrical contact with said second conductive tape separator.

17. The cable according to claim 14, wherein said third conductive tape separator is formed of at least two layers, with a first layer being conductive and a second layer being nonconductive.

18. The cable according to claim 17, wherein said first conductive layer of said third conductive tape separator is in direct electrical contact with both of said first conductive tape separator and said second conductive tape separator, and wherein said third conductive tape separator includes at least one fold where the third conductive tape separator is folded back onto itself.

19. The cable according to claim 13, wherein said outer shielding layer is in electrical contact with said first conductive tape separator and said second conductive tape separator.

20. The cable according to claim 13, wherein said outer shielding layer is formed of at least two layers, with a first layer being conductive and a second layer being nonconductive, and wherein said conductive layer of said outer shielding layer is in direct electrical contact with said first conductive tape separator in a first area adjacent said first twisted pair and in a second area adjacent said fourth twisted pair, and wherein said conductive layer of said outer shielding layer is in direct electrical contact with said second conductive tape separator in a third area adjacent said third twisted pair and in a fourth area adjacent said second twisted pair.
